(19) United States
(12) Patent Application Publication
(10) Pub. No.: US 2011/0285853 A1
(43) Pub. Date: Nov. 24, 2011

(54) MOVEMENT DETECTION SYSTEM AND MOVEMENT SENSING FOOTWEAR

(76) Inventor: Li-Jung Chu, Taichung City (TW)

(21) Appl. No.: 13/110,543

(22) Filed: May 18, 2011

(30) Foreign Application Priority Data
May 24, 2010 (TW) 099116507

(51) Int. Cl. H04N 5/33; F21V 21/08

(52) U.S. Cl. 348/164; 362/103; 348/E05.09

(57) ABSTRACT

A movement detection system includes: a movement sensing footwear operable for providing an infrared signal, and for generating and wirelessly transmitting a footwear motion signal that corresponds to acceleration of the movement sensing footwear; an image acquisition module for capturing images that contain the infrared signal; and a data processing device connected electrically to the image acquisition module for receiving the images captured by the image acquisition module, including a wireless receiver module for receiving the footwear motion signal transmitted by the wireless transmitter module, and configured to acquire information corresponding to acceleration of the movement sensing footwear based on the footwear motion signal, and to acquire information corresponding to position of the movement sensing footwear relative to the image acquisition module based on the images captured by the image acquisition module.

### CROSS-REFERENCE TO RELATED APPLICATION

This application claims priority of Taiwanese Application No. 099116507, filed on May 24, 2010.

### BACKGROUND OF THE INVENTION

1. Field of the Invention

The present invention relates to footwear, more particularly to a movement sensing footwear and a movement detection system having the same.

2. Description of the Related Art

Recently, more and more video game consoles include mechanisms for detecting user movement. For example, a wireless controller for Nintendo Wii may include a single-axis accelerometer for detecting hand movement of a user.

However, since the single-axis accelerometer is unable to detect user movement in more than one direction, a user of the video game console may learn that a swing by the wrist is substantially equivalent to that by the arm in terms of effect, which could severely reduce the interactivity between the game and the user and could defeat the purpose of the game.

In addition, the wireless controller is designed to be handheld and is unable to provide the effect of force feedback. As a result, injuries may occur when the user exerts excessive force or as a result of long-term use.

### SUMMARY OF THE INVENTION

Therefore, an object of the present invention is to provide a movement detection system capable of alleviating at least one of the aforesaid drawbacks of the prior art.

According to the present invention, a movement detection system includes:

a movement sensing footwear including
a footwear body,
a signal providing module disposed on the footwear body for providing an infrared signal, an inertial sensor module disposed on the footwear body and operable to generate an inertia signal corresponding to acceleration of the footwear body measured by the inertial sensor module,
a computation module connected electrically to the inertial sensor module for receiving the inertia signal therefrom and operable to generate a footwear motion signal based on the inertia signal, and
a wireless transmitter module connected electrically to the computation module for transmitting the footwear motion signal;

an image acquisition module for capturing images that contain the infrared signal; and

a data processing device connected electrically to the image acquisition module for receiving the images captured by the image acquisition module, including a wireless receiver module for receiving the footwear motion signal transmitted by the wireless transmitter module, and configured to acquire information corresponding to acceleration of the movement sensing footwear based on the footwear motion signal, and to acquire information corresponding to position of the movement sensing footwear relative to the image acquisition module based on the images captured by the image acquisition module.

Another object of the present invention is to provide a movement sensing footwear capable of alleviating at least one of the aforesaid drawbacks of the prior art.

According to the present invention, a movement sensing footwear includes:

a footwear body;

a signal providing module disposed on the footwear body for providing an infrared signal; and

an inertial sensor module disposed on the footwear body and operable to generate an inertia signal corresponding to acceleration of the footwear body measured by the inertial sensor module.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram to illustrate a movement sensing footwear of the first preferred embodiment of a movement detection system of the present invention;

FIG. 2 is a block diagram to illustrate the movement detection system;

FIG. 3 is a block diagram to illustrate the movement sensing footwear;

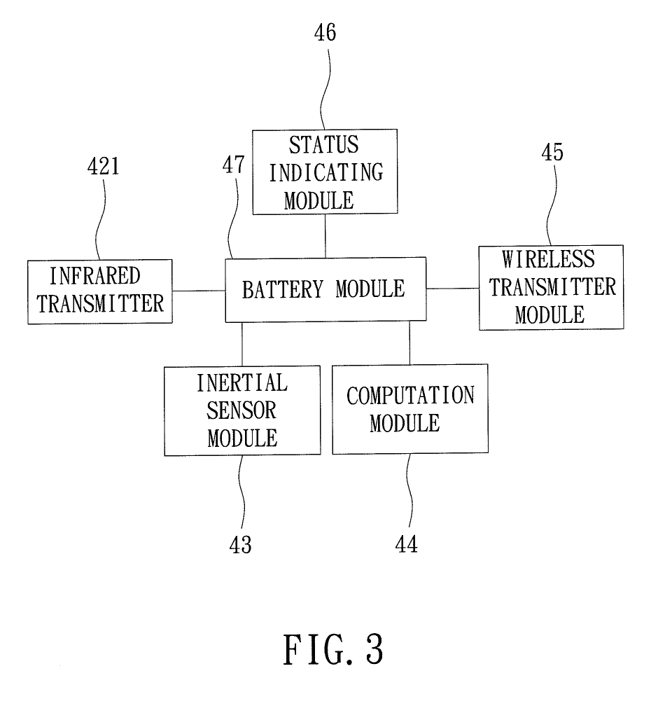

FIG. 4 is a schematic diagram to illustrate a movement sensing footwear of the second preferred embodiment of a movement detection system of the present invention;

FIG. 5 is a block diagram to illustrate the movement detection system of the second preferred embodiment; and

FIG. 6 is a block diagram to illustrate the movement sensing footwear of the movement detection system of the second preferred embodiment.

### DETAILED DESCRIPTION OF THE PREFERRED EMBODIMENTS

Before the present invention is described in greater detail, it should be noted that like elements are denoted by the same reference numerals throughout the disclosure.

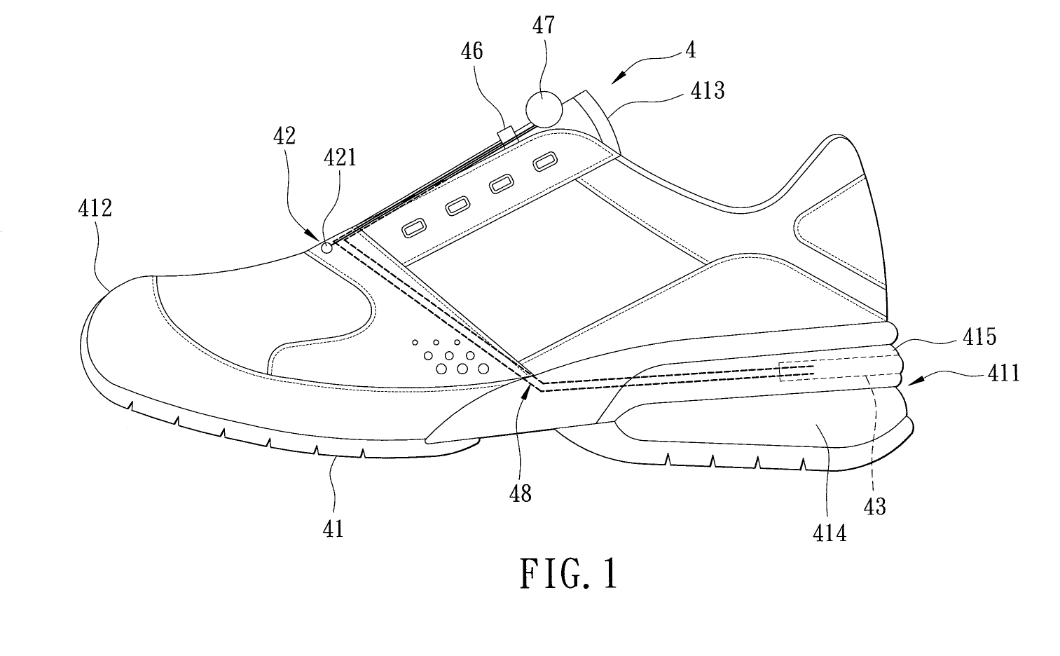

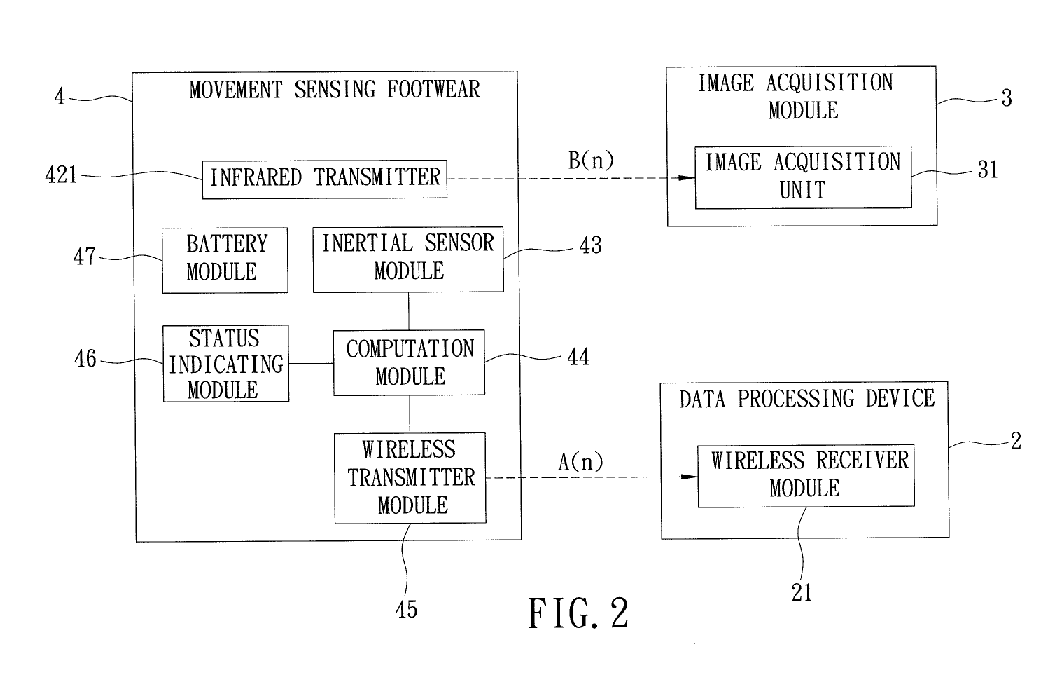

Referring to FIGS. 1 and 2, the first preferred embodiment of a movement detection system according to the present invention includes a data processing device 2, an image acquisition module 3, and a movement sensing footwear 4.

The data processing device 2 may be a personal computer or a video game console including a wireless receiver module 21 (e.g., a Bluetooth module) operable for receiving a footwear motion signal A(n). The image acquisition module 3 is connected electrically to the data processing device 2, and includes an image acquisition unit 31 operable for capturing images that contain an infrared signal B(n). In this embodiment, the image acquisition unit 31 is a webcam mounted with an infrared lens filter.

The movement sensing footwear 4 includes a footwear body 41, a signal providing module 42, an inertial sensor module 43, a computation module 44, a wireless transmitter module 45, a status indicating module 46, and a battery module 47.

The footwear body 41 includes a sole portion 411, an upper portion 412 connected to the sole portion 411, and a tongue portion 413 connected to the upper portion 412. The sole portion 411 has a buffer part 414 that is filled with a fluid, and a shock absorbing part 415 that is connected to the buffer part 414 and that serves to absorb shock force. In this embodiment, the fluid in the buffer part 414 is air. However, in other embodiments, the fluid in the buffer part 414 may be otherwise. The shock absorbing part 415 includes a material selected from latex, polyurethane (PU), ethylene vinylacetate copolymer (EVA), thermal plastic rubber (TPR), and combinations thereof.

The signal providing module 42 includes an infrared transmitter 421 disposed at the tongue portion 413, and operable to transmit the infrared signal B(n). In this embodiment, the infrared transmitter 421 is an infrared light-emitting diode (LED) operable for emitting infrared light.

In this embodiment, the inertial sensor module 43 is a three-axis accelerometer disposed in the shock absorbing part 415, and operable to generate an inertia signal corresponding to acceleration of the footwear body 41 measured by the inertial sensor module 43.

In this embodiment, the computation module 44 is a microprocessor control unit connected electrically to the inertial sensor module 43 for receiving the inertia signal therefrom, and is operable to generate the footwear motion signal A(n) based on the inertia signal. The wireless transmitter module 45 is connected electrically to the computation module 44 for transmitting the footwear motion signal A(n) to the wireless receiver module 21 of the data processing device 2. In this embodiment, the wireless transmitter module 45 and the inertial sensor module 43 are assembled together, are disposed in the shock absorbing part 415, and are coated with a polymeric material.

The status indicating module 46 is mounted on the tongue portion 413 of the footwear body 41, and is connected electrically to and controlled by the computation module 44 for indicating an operational status (e.g., battery status and wireless connection status) of the movement sensing footwear 4. In this embodiment, the status indicating module 46 includes a plurality of light-emitting diodes for visual indication of the operational status of the movement sensing footwear 4.

The battery module 47 is disposed proximate to a distal end of the tongue portion 413 distal from the upper portion 412, and is connected electrically to the infrared transmitter 421, the inertial sensor module 43, the computation module 44, the wireless transmitter module 45, and the status indicating module 46 for providing power thereto. In this embodiment, the movement sensing footwear 4 further includes a multi-wire planar cable unit 48, which is durable to wearing, bending, and stretching, for interconnecting electrically the computation module 44 and the inertial sensor module 43, and the wireless transmitter module 45 and the computation module 44.

Upon receipt of the footwear motion signal A(n) via the wireless receiver module 21, the data processing device 2 is configured to acquire information corresponding to acceleration of the movement sensing footwear 4 in the three axes based on the footwear motion signal A(n).

The data processing device 2 is further configured to receive the images captured by the image acquisition module 3 from the image acquisition module 3, and to acquire information corresponding to position of the movement sensing footwear 4 relative to the image acquisition module 3 based on the images captured by the image acquisition module 3.

The information thus acquired may be used in various games and applications (e.g., a game where fitness of a user is to be measured).

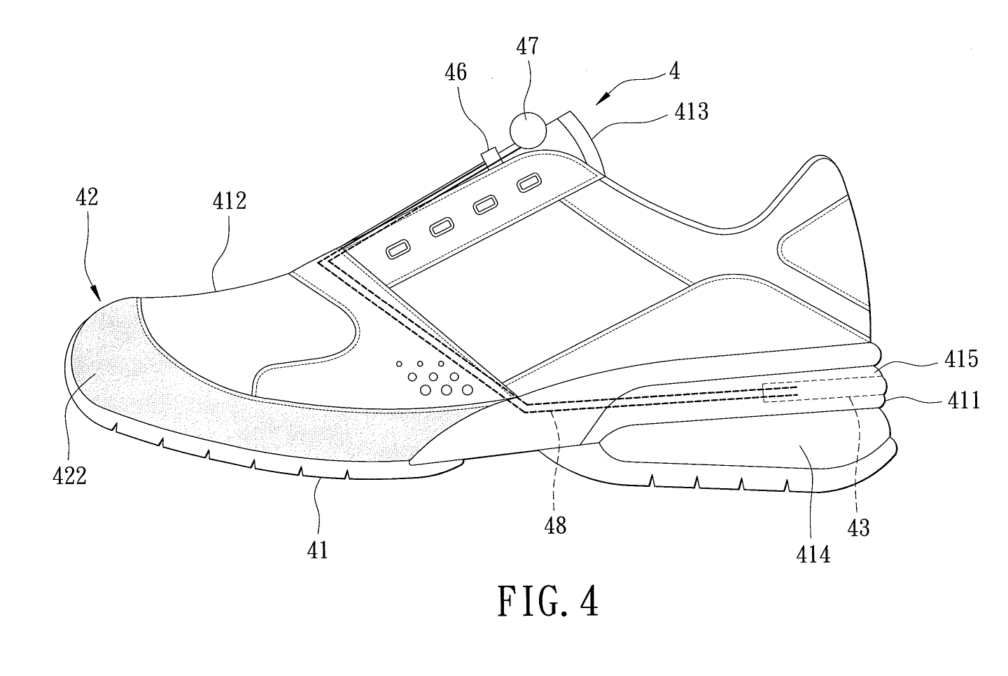

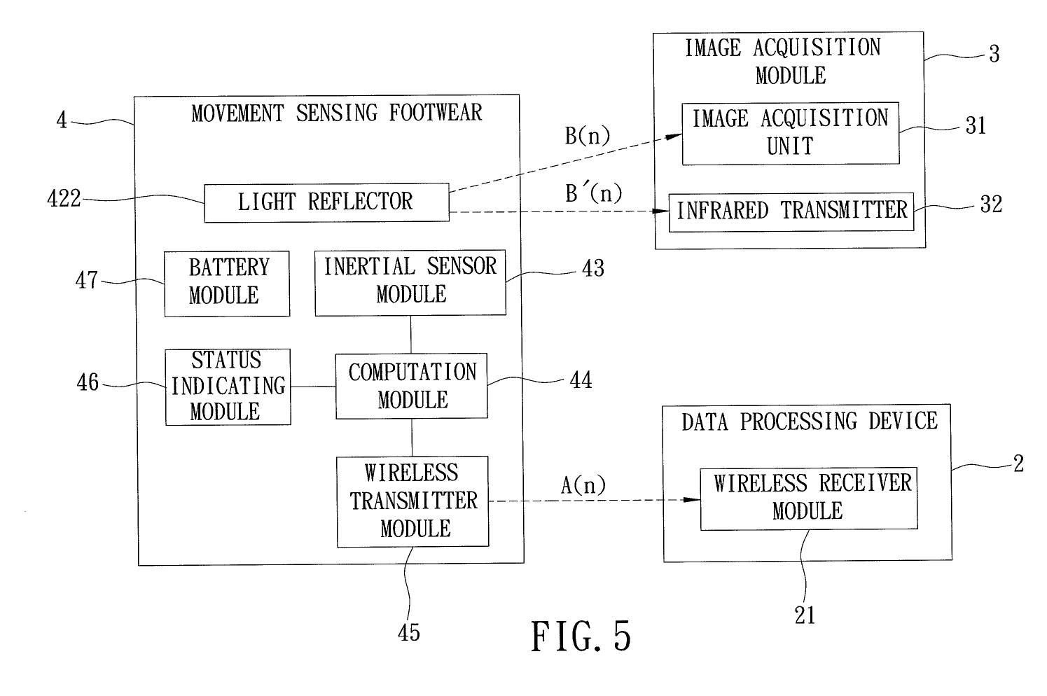

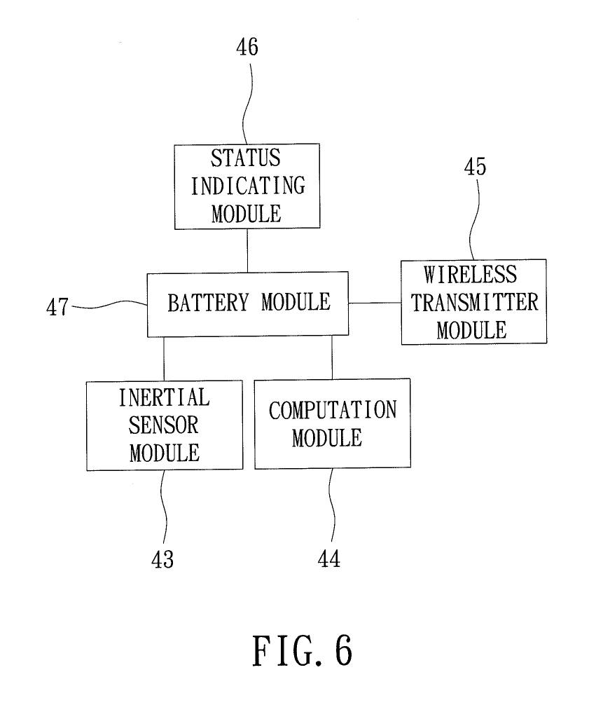

Referring to FIGS. 4 to 6, the difference between the first and second preferred embodiments resides in that, in the second preferred embodiment, the image acquisition module 3 further includes an infrared transmitter 32 operable for transmitting a to-be-reflected infrared signal B′(n), and the signal providing module 42 of the movement sensing footwear 4 includes a light reflector 422 that is disposed on an outer surface of the footwear body 41 and that serves to reflect the to-be-reflected infrared signal B′(n). The to-be-reflected infrared signal B′ (n) reflected by the light reflector 422 serves as the infrared signal B(n). In the second preferred embodiment, the infrared transmitter 32 is a 8×6 infrared LED array, and the light reflector 422 is made of a light-reflective material having a reflectivity greater than 450 cd/lx.sqm.

In summary, the data processing device 2 is able to acquire information corresponding to acceleration and position of the movement sensing footwear 4.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A movement detection system comprising:
a movement sensing footwear including
a footwear body,
a signal providing module disposed on said footwear body for providing an infrared signal,
an inertial sensor module disposed on said footwear body and operable to generate an inertia signal corresponding to acceleration of said footwear body measured by said inertial sensor module,
a computation module connected electrically to said inertial sensor module for receiving the inertia signal therefrom and operable to generate a footwear motion signal based on the inertia signal, and
a wireless transmitter module connected electrically to said computation module for transmitting the footwear motion signal;
an image acquisition module for capturing images that contain the infrared signal; and
a data processing device connected electrically to said image acquisition module for receiving the images captured by said image acquisition module, including a wireless receiver module for receiving the footwear motion signal transmitted by said wireless transmitter module, and configured to acquire information corresponding to acceleration of said movement sensing footwear based on the footwear motion signal, and to acquire information corresponding to position of said movement sensing footwear relative to said image acquisition module based on the images captured by said image acquisition module.

2. The movement detection system as claimed in claim 1, wherein said footwear body has a tongue portion, and said signal providing module includes an infrared transmitter disposed at said tongue portion and operable to transmit the infrared signal.

3. The movement detection system as claimed in claim 1, wherein said footwear body has a sole portion including a shock absorbing part, and said inertial sensor module is disposed in said shock absorbing part.

4. The movement detection system as claimed in claim 3, wherein said sole portion further includes a buffer part that is filled with a fluid and that is connected to said shock absorbing part.

5. The movement detection system as claimed in claim 1, wherein said image acquisition module includes a webcam mounted with an infrared lens filter.

6. The movement detection system as claimed in claim 1, wherein said movement sensing footwear further includes a status indicating module mounted on said footwear body, and connected electrically to and controlled by said computation module for indicating an operational status of said movement sensing footwear.

7. The movement detection system as claimed in claim 6, wherein said status indicating module includes a light-emitting diode for visual indication of the operational status of said movement sensing footwear.

8. The movement detection system as claimed in claim 1, further comprising an infrared transmitter for transmitting a to-be-reflected infrared signal, said signal providing module including a light reflector that is disposed on said footwear body and that serves to reflect the to-be-reflected infrared signal, the to-be-reflected infrared signal reflected by said light reflector serving as the infrared signal.

9. The movement detection system as claimed in claim 8, wherein said light reflector is made of a material having a reflectivity greater than 450 cd/lx.sqm.

10. The movement detection system as claimed in claim 1, wherein said movement sensing footwear further includes a multi-wire planar cable unit for interconnecting electrically said computation module and said inertial sensor module, and said wireless transmitter module and said computation module.

11. A movement sensing footwear comprising:
a footwear body;
a signal providing module disposed on said footwear body for providing an infrared signal; and
an inertial sensor module disposed on said footwear body and operable to generate an inertia signal corresponding to acceleration of said footwear body measured by said inertial sensor module.

12. The movement sensing footwear as claimed in claim 11, further comprising a computation module connected electrically to said inertial sensor module for receiving the inertia signal therefrom and operable to generate a footwear motion signal based on the inertia signal, and a wireless transmitter module connected electrically to said computation module for transmitting the footwear motion signal.

13. The movement sensing footwear as claimed in claim 11, wherein said footwear body has a tongue portion, and said signal providing module includes an infrared transmitter disposed at said tongue portion and operable to transmit the infrared signal.

14. The movement sensing footwear as claimed in claim 11, wherein said footwear body has a sole portion including a shock absorbing part, and said inertial sensor module is disposed in said shock absorbing part.

15. The movement sensing footwear as claimed in claim 14, wherein said sole portion further includes a buffer part that is filled with a fluid and that is connected to said shock absorbing part.

16. The movement sensing footwear as claimed in claim 12, further comprising a status indicating module mounted on said footwear body and connected electrically to and controlled by said computation module for indicating an operational status of said movement sensing footwear.

17. The movement sensing footwear as claimed in claim 16, wherein said status indicating module includes a light-emitting diode for visual indication of the operational status of said movement sensing footwear.

18. The movement sensing footwear as claimed in claim 16, further comprising a battery module mounted on said footwear body and connected electrically to said computation module and said status indicating module.

19. The movement sensing footwear as claimed in claim 11, wherein said signal providing module includes a light reflector that is disposed on said footwear body and that serves to reflect a to-be-reflected infrared signal, the to-be-reflected infrared signal reflected by said light reflector serving as the infrared signal.

20. The movement sensing footwear as claimed in claim 19, wherein said light reflector is made of a material having a reflectivity greater than 450 cd/lx.sqm.

21. The movement sensing footwear as claimed in claim 12, further comprising a multi-wire planar cable unit interconnecting electrically said computation module and said inertial sensor module, and said wireless transmitter module and said computation module.
